(19) United States
(12) Patent Application Publication
(10) Pub. No.: US 2020/0272591 A1
(43) Pub. Date: Aug. 27, 2020

(54) PORT CIRCUIT, METHOD FOR SUPPLYING POWER FOR ELECTRONIC DEVICE VIA PORT CIRCUIT AND ELECTRONIC DEVICE

(71) Applicant: Sony Corporation, Tokyo (JP)

(72) Inventors: Yaofeng SHI, Beijing (CN); Xiaoxia SUN, Beijing (CN); Haoyu LI, Beijing (CN); Yuling LIU, Beijing (CN)

(21) Appl. No.: 16/646,075

(22) PCT Filed: Dec. 15, 2017
(86) PCT No.: PCT/CN2017/116449

§ 371 Date: Mar. 10, 2020

(51) Int. Cl. G06F 13/40; G06F 1/26

(52) U.S. Cl. CPC G06F 13/4022; G06F 1/266

(57) ABSTRACT

A port circuit, method for supplying power for an electronic device via a port circuit and electronic device. The port circuit includes: power supply pins configured to connect power lines of an external device and power lines of an electronic device provided with the port circuit; data pins configured to connect data lines of the external device and data lines of the electronic device; and first switch configured to switch between switching on and turning off, so that a path for performing data exchange by the electronic device and the external device is switched on or turned off. With the method for supplying power for an electronic device via a port circuit and the electronic device, whether the electronic device exchanges data with the external device via the data pins of the port circuit is controlled by providing a switch at the port circuit, thereby guaranteeing information security of the electronic device.

### TECHNICAL FIELD

This disclosure relates to the field of electronic circuits, and in particular to a port circuit, method for supplying power for an electronic device via a port circuit and electronic device.

### BACKGROUND

An electronic device is usually provided with a built-in chargeable battery, and when residual electricity of the chargeable battery charge is low, external power supplies may supply power for the electronic device via a port circuit of the electronic device. The port circuit is often provided with charge pins and data pins therein. The charge pins may supply power for the chargeable battery, and the data pins are used for data exchange between the electronic device and an external device. A common port circuit may be, for example, a universal serial bus (USB) port circuit.

When power supply plugs of some external power supplies are plugged into the port circuit to supply power for the electronic device, data pins of the power supply plugs may contact the data pins in the port circuit, so that the external power supplies exchange data with the electronic device via the port circuit; for example, the external power supplies may read data from and/or write data in the electronic device via the port circuit.

It should be noted that the above description of the background art is merely provided for clear and complete explanation of this disclosure and for easy understanding by those skilled in the art. It should not be understood that the above technical solution is known to those skilled in the art as it is described in the background art of this disclosure.

### SUMMARY

It was found by the inventors of this disclosure that when the power supply plugs of the external power supplies are plugged into the port circuit to supply power for the electronic device, some external power supplies may exchange data with the electronic device via the port circuit. Hence, a relatively large risk exists for information of the electronic device. For example, the external power supplies may read data from the electronic device, or the external power supplies may write Trojan applications in the electronic device, etc. Especially, when a user uses a common power supply to supply power for the electronic device, risks for information security of the above information will become larger. For example, the common power supply may be a sharing charger, etc.

Embodiments of this disclosure provide a port circuit, a method for supplying power for an electronic device via a port circuit and an electronic device, in which switching on or turning off of a path for performing data exchange between the electronic device and an external device is controlled by providing a switch at the port circuit, thereby guaranteeing information security of the electronic device.

According to one aspect of the embodiments of this disclosure, there is provided a port circuit, including:

power supply pins configured to connect power lines of an external device and power lines of an electronic device provided with the port circuit; data pins configured to connect data lines of the external device and data lines of the electronic device; and a first switch configured to switch between switching on and turning off, so that a path for performing data exchange between the electronic device and the external device is switched on or turned off.

According to another aspect of the embodiments of this disclosure, when the first switch is switched on or turned off, the data pins are insulated from the data line of the external device, and/or the data pins are interrupted.

According to a further aspect of the embodiments of this disclosure, the first switch is mechanical switch or electronic switch.

According to still another aspect of the embodiments of this disclosure, the first switch is an electronic switch, and the port circuit further includes:

a control signal generator connected to the electronic switch and generating a control signal making the electronic switch switched on or turned off.

According to yet another aspect of the embodiments of this disclosure, the number of the data pins is at least two, and the port circuit further includes:

a second switch connected to the at least two data pins, and making the at least two data pins electrically connect when the first switch makes the path for performing data exchange between the electronic device and the external device turned off.

According to further still another aspect of the embodiments of this disclosure, there is provided an electronic device, including the port circuit as described in any one of the above aspects.

According to yet still another aspect of the embodiments of this disclosure, the electronic device further includes:

a controller, when detecting that the at least two data pins of the port circuit electrically connect, making the electronic device to receive power supply from the external device via the power supply pins of the port circuit.

According to a yet further aspect of the embodiments of this disclosure, there is provided a method for supplying power for an electronic device via a port circuit, including:

supplying power by an external device for an electronic device provided with a port circuit via power supply pins of the port circuit; and

controlling a path for performing data exchange by the electronic device and the external device provided by data pins located in the same port circuit as the power supply pins to be switched on or turned off by switching of a first switch between switching on and turning off.

According to a yet further another aspect of the embodiments of this disclosure, the method further includes:

generating a control signal making the electronic switch switched on or turned off.

According to yet further still another aspect of the embodiments of this disclosure, the number of the data pins is at least two, and the method further includes: making the at least two data pins electrically connect via a second switch when the first switch makes the path for performing data exchange between the electronic device and the external device turned off.

An advantage of the embodiments of this disclosure exists in that switching on or turning off of the path for performing data exchange by the electronic device and the external device is controlled by providing a switch at the port circuit, thereby guaranteeing information security of the electronic device.

With reference to the following description and drawings, the particular embodiments of this disclosure are disclosed in detail, and the principles of this disclosure and the manners of use are indicated. It should be understood that the scope of the embodiments of this disclosure is not limited thereto. The embodiments of this disclosure contain many alternations, modifications and equivalents within the spirit and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

The drawings are included to provide further understanding of the present disclosure, which constitute a part of the specification and illustrate the preferred embodiments of the present disclosure, and are used for setting forth the principles of the present disclosure together with the description. It is to be understood that the accompanying drawings in the following description are some embodiments of this disclosure, and for those of ordinary skills in the art, other accompanying drawings may be obtained according to these accompanying drawings without making an inventive effort. In the drawings:

FIG. 1 is a schematic diagram of the port circuit of Embodiment 1 of this disclosure;

FIG. 2 is a schematic diagram of the data pin being insulated from the data line of the external device when the switch of Embodiment 1 is turned off;

FIG. 3 is a schematic diagram of the data pin being interrupted when the switch of Embodiment 1 is turned off;

FIG. 4 is another schematic diagram of the data pin being insulated from the data line of the external device when the switch of Embodiment 1 is turned off;

FIG. 5 is another schematic diagram of the data pin being interrupted when the switch of Embodiment 1 is turned off;

FIG. 6 is a schematic diagram of providing the electronic switch between the data pin and the external device of Embodiment 1 of this disclosure;

FIG. 7 is a schematic diagram of providing the electronic switch between a first part and a second part of the data pin of Embodiment 1 of this disclosure;

FIG. 8 is a schematic diagram of the second switch 105 being connected to the data pins 102A and 102B of Embodiment 1 of this disclosure;

FIG. 9 is a schematic diagram of the second switch 105 being connected to the first parts 1021A and 1021B of Embodiment 1 of this disclosure;

FIG. 10 is a flowchart of the method of Embodiment 2 of this disclosure; and

FIG. 11 is a schematic diagram of a systematic structure of the electronic device of Embodiment 3 of this disclosure.

### DETAILED DESCRIPTION OF THE DISCLOSURE

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims. Various embodiments of this disclosure shall be described below with reference to the accompanying drawings. These embodiments are illustrative only, and not intended to limit this disclosure.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not be defined as a meaning of “one”; and the term “the” should be understood as including both a single form and a plural form, except as specified otherwise. Furthermore, the term “according to” should be understood as “at least partially according to”, the term “based on” should be understood as “at least partially based on”, except as specified otherwise.

### Embodiment 1

The embodiment of this disclosure provides a port circuit.

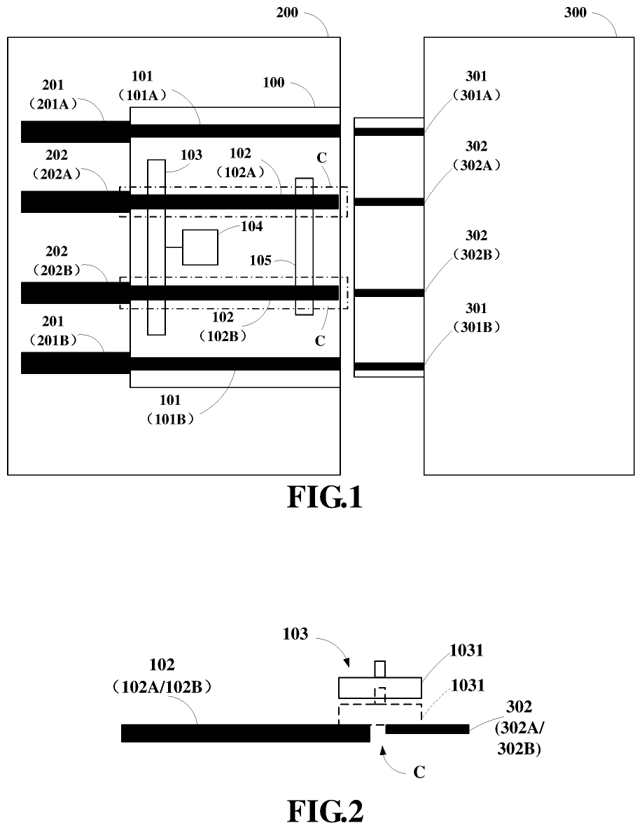

FIG. 1 is a schematic diagram of the port circuit. As shown in FIG. 1, the port circuit 100 includes power supply pins 101, data pins 102 and a first switch 103.

In this embodiment, the power supply pins 101 are configured to connect with an external device 300. The external device 300 supplies power for an electronic device 200 provided with the port circuit 100. The data pins 102 provide a path C for performing data exchange between the electronic device 200 and the external device 300; and the first switch 103 is configured to control switching on and turning off of the path C.

According to this embodiment, switching on or turning off of the path C for performing data exchange by the electronic device and an external device is controlled by providing a switch at the port circuit. Hence, when the external device supplies power for the electronic device via the port circuit, the electronic device may be prohibited from exchanging data with the external device via the port circuit, thereby guaranteeing information security of the electronic device.

In this embodiment, as shown in FIG. 1, the number of the power supply pins 101 may be two, denoted respectively by 101A and 101B. The power supply pin 101A is used to supply a power supply voltage, and the power supply pin 101B is used to supply a ground voltage.

In this embodiment, the power supply pins 101 may be respectively connected to power lines 201 of the electronic device 200 and power lines 301 of the external device 300, hence, the external device 300 may supply power for the electronic device 200 via the power supply pins 101. The power supply of the external device 300 for the electronic device 200 may support operation of the electronic device and/or may charge a chargeable battery in the electronic device 200. For example, the power supply pin 101A is connected to a power line 201A of the electronic device 200 and a power line 301A of the external device 300, and the power supply pin 101B is connected to a power line 201B of the electronic device 200 and a power line 301B of the external device 300.

In this embodiment, the number of the data pins 102 may be at least two. In this embodiment, description shall be given by taking two data pins as an example. However, this embodiment is not limited thereto, and the number of the data pins 102 may be more than two.

As shown in FIG. 1, two data pins may be respectively denoted by 102A and 102B. The data pins 102 may be used to be connected to data lines 202 of the electronic device 200. For example, the data pin 102A may be used to be connected to a positive data line 202A of the electronic device 200, and the data pin 102B may be used to be connected to a negative data line 202B of the electronic device 200. The data pins 102 may also be used to be connected to data lines 302 of the external device 300. For example, the data pin 102A may be used to be connected to a positive data line 302A of the external device 300, and the data pin 102B may be used to be connected to a negative data line 302B of the external device 300.

In this embodiment, the first switch 103 switches between switching on and turning off, so that the path C is switched on or turned off, hence, the path C for performing data exchange by the electronic device 200 and the external device 300 is switched on or turned off.

In this embodiment, when the first switch 103 is turned off, the path C may be turned off. For example, when the first switch 103 is turned off, the data pins 102 may be insulated from the data lines 302 of the external device 300, and/or the data pins 102 are interrupted. Furthermore, this embodiment may not be limited thereto. For example, a manner of the first switch 103 for controlling switching on or turning off of the path C may be that when the first switch 103 is switched on, the path C is turned off. For example, when the first switch 103 is switched on, the data pins 102 may be insulated from the data lines 302 of the external device 300, and/or the data pins 102 are interrupted.

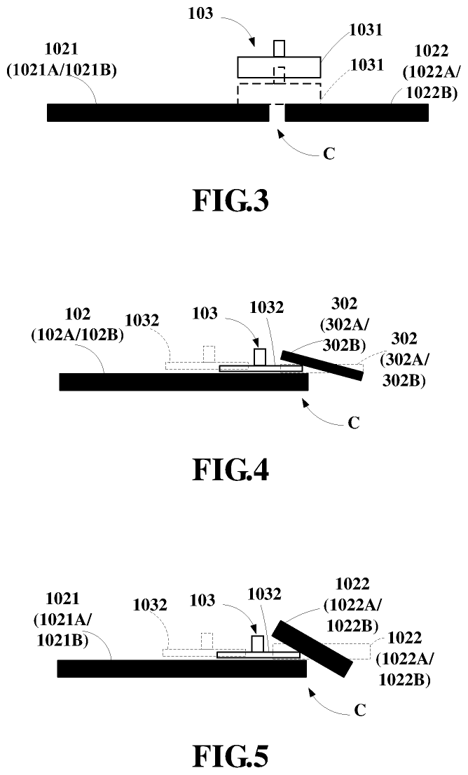

FIG. 2 is a schematic diagram of the data pins 102 being insulated from the data lines 302 of the external device 300 when the first switch 103 is turned off. As shown in FIG. 2, the first switch 103 may include a conductive portion 1031. As shown by the dotted lines, when the first switch 103 is switched on, the conductive portion 1031 is connected to both the data pin 102 and the data line 302 of the external device 300, so that the path C is switched on. When the first switch 103 is turned off, the conductive portion 1031 is insulated from the data pin 102 and/or the data line 302 of the external device 300, so that the path C is turned off FIG. 3 is a schematic diagram of the data pins 102 being turned off when the first switch 103 is turned off. As shown in FIG. 3, the first switch 103 may include a first part 1021 and a second part 1022. The first part 1021 is connected to the data line 202, the second part 1022 is used to be connected to the data line 302, and the first switch 103 is provided between the first part 1021 and the second part 1022. As shown in FIG. 3, as shown by the dotted lines, when the first switch 103 is switched on, the conductive portion 1031 is connected to both the first part 1021 and the second part 1022 of the data pin 102, so that the path C is switched on. When the first switch 103 is turned off, the conductive portion 1031 is not connected the first part 1021 or the second part 1022, so that the path C is turned off.

In this embodiment, the first switch 103 is provided at either position shown in FIGS. 2 and 3. Furthermore, the number of the first switch(es) 103 may be at least two, which may be located respectively at the positions shown in FIGS. 2 and 3.

In the examples shown in FIGS. 2 and 3, the path C may be turned off by removing the conductive portion 1031 of the first switch 103 from the path C; however, this embodiment is not limited thereto, and the path C may be turned off by inserting an insulation portion of the first switch 103 into the path C.

FIG. 4 is another schematic diagram of the data pin 102 being insulated from the data line 302 of the external device 300 when the first switch 103 is turned off. As shown in FIG. 4, the first switch 103 may include an insulation portion 1032. As shown by the dotted lines, when the first switch 103 is switched on, the insulation portion 1032 is removed from the data pin 102 and the data line 302 of the external device 300, the data pin 102 and the data line 302 are connected, hence, the path C is switched on; and when the first switch 103 is turned off, the insulation portion 1032 is inserted between the data pin 102 and the data line 302 of the external device 300, hence, the path C is turned off.

FIG. 5 is another schematic diagram of the data pin 102 being turned off when the first switch 103 is turned off. As shown in FIG. 5, as shown by the dotted lines, when the first switch 103 is switched on, the insulation portion 1032 is removed from between the first part 1021 and the second part 1022 of the data pin 102, the first part 1021 and the second part 1022 are connected, hence, the path C is switched on; and when the first switch 103 is turned off, the insulation portion 1032 is inserted between the first part 1021 and the second part 1022 of the data pin 102, hence, the path C is turned off.

In FIGS. 2-5 of this embodiment, the first switches 103 are mechanical switches. However, this embodiment is not limited thereto, and the first switches 103 may also or alternatively be electronic switches.

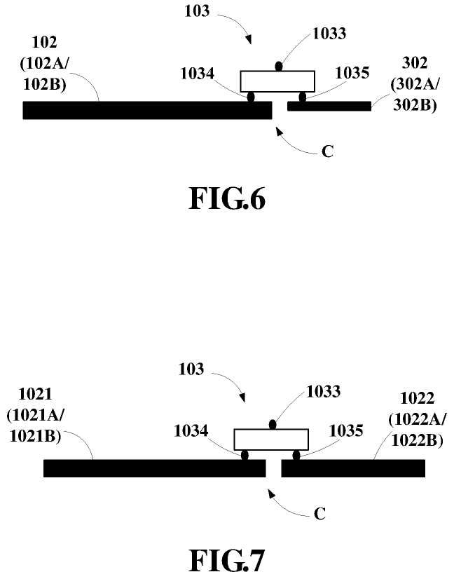

FIG. 6 is a schematic diagram of providing an electronic switch between the data pin 102 and the data line 302 of the external device 300. As shown in FIG. 6, the first switch 103 is an electronic switch, and may include a control terminal 1033, a first connection terminal 1034 and a second connection terminal 1035. The first connection terminal 1034 and the second connection terminal 1035 are connected respectively to the data pin 102 and the data line 302 of the external device 300. When the control terminal 1033 is inputted a conductance control signal, the path C is switched on; and when the control terminal 1033 is inputted a disconnection control signal, the path C is turned off. The first switch 103 taken as electronic switch may include, for example, a bipolar transistor, and/or a field effect transistor (FET).

FIG. 7 is a schematic diagram of providing the electronic switch between the first part and the second part of the data pin. As shown in FIG. 7, the first connection terminal 1034 and the second connection terminal 1035 of the first switch 103 are connected respectively to the first part 1021 and the second part 1022 of the data pin 102. When the control terminal 1033 is inputted a conductance control signal, the path C is switched on; and when the control terminal 1033 is inputted a disconnection control signal or the control signal is turned off, the path C is turned off.

In this embodiment, various implementations of the first switch 103 are described in FIGS. 2-7. However, this embodiment is not limited thereto, and the first switch 103 may also be switches of other types, and may be provided at other positions.

In this embodiment, as shown in FIG. 1, the port circuit 100 may further include a control signal generator 104. When the first switch 103 is an electronic switch, the control signal generator 104 may generate a conductance control signal or a disconnection control signal making the first switch 103 switched on or turned off. In this embodiment, the conductance control signal or the disconnection control signal generated by the control signal generator 104 may be inputted into the control terminal 1033 of the first switches 103 shown in FIGS. 6 and 7, so that the path C is switched on or turned off.

In the above explanation of this embodiment, descriptions of the data pin 102 are applicable to the data pin 102A and the data pin 102B, descriptions of the power supply pin 101 are applicable to the power supply pin 101A and the power supply pin 101B, descriptions of the first part 1021 and the second part 1022 of the data pin 102 are respectively applicable to the first parts 1021A and 1021B and the second parts 1022A and 1022B of the data pins, descriptions of the data lines 202 are applicable to the data lines 202A and 202B, descriptions of the power supply line 201 are applicable to the power supply lines 201A and 201B, descriptions of the data line 302 are applicable to the data lines 302A and 302B, and descriptions of the power supply line 301 are applicable to the power supply lines 301A and 301B.

In this embodiment, as shown in FIG. 1, the port circuit 100 may further include a second switch 105. The second switch 105 may be connected to the at least two data pins 102, and may make the at least two data pins 102 shorted when the first switch 103 makes the path C, for example, turned off. For example, in FIG. 1, the second switch 105 may be connected to the data pins 102A and 102B, and may make the data pins 102A and 102B shorted when the first switch 103 makes the path turned off.

In this embodiment, the second switch 105 makes the data pins 102A and 102B shorted (i.e. electrically connected), which may enable the data lines 202A and 202B of the electronic device to be at the same potential. Hence, the electronic device 200 may control when the data lines 202A and 202B are detected as being at the same potential, so as to receive power supply from the external device via the power supply pins 101 of the port circuit 100. For example, the electronic device may control, so as to permit power transmitted via the power supply pins 101 of the port circuit 100 to charge the chargeable battery of the electronic device 200.

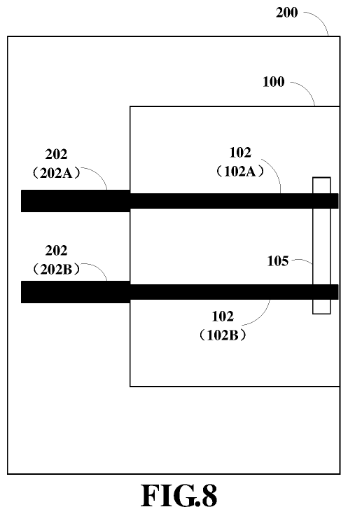

In this embodiment, when the first switches 103 are connected in the manners shown in FIGS. 2, 4 and 6, the second switch 105 may be connected to the data pins 102A and 102B at any positions. FIG. 8 is a schematic diagram of the second switch 105 being connected to the data pins 102A and 102B. As shown in FIG. 8, when the first switch 103 make the data pins 102A and 102B insulated from the data lines 302A and 302B, the second switch 105 may make the data pins 102A and 102B shorted, hence, the electronic device may detect that the data lines 202A and 202B are at the same potential. Furthermore, in this embodiment, positions where the second switch 105 and the data pins 102A and 102B are connected are not limited to those shown in FIG. 8.

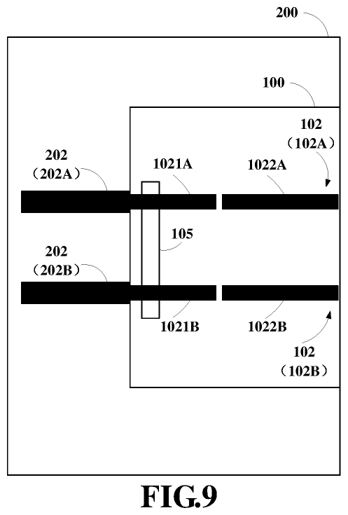

In this embodiment, when the first switches 103 are connected in the manners shown in FIGS. 3, 5 and 7, the second switch 105 may be connected to the first parts 1021A and 1021B of the data pins at any positions. FIG. 9 is a schematic diagram of the second switch 105 being connected to the first parts 1021A and 1021B of the data pins. As shown in FIG. 9, when the first switch 103 makes the first parts 1021A and 1021B insulated from the second parts 1022A and 1022B, the second switch 105 may make the first parts 1021A and 1021B of the data pins shorted, hence, the electronic device 200 may detect that the data lines 202A and 202B are at the same potential. Furthermore, in this embodiment, positions where the second switch 105 connects the first parts 1021A and 1021B of the data pins are not limited to those shown in FIG. 9.

In this embodiment, the second switch 105 may control the data pins 102A and 102B to be shorted or insulated by switch between switching on and turning off. The second switch 105 may be a mechanical switch, or an electronic switch. Description of the first switches 103 shown in FIGS. 2, 4 and 6 may be referred to for a structure and a manner of connection of the second switch 105. In this embodiment, when the first switches 103 and the second switch 105 are mechanical switches, they may be linked via a transmission mechanism (not shown), hence, when the first switches 103 make the path C turned off, the second switch 105 makes the data pins 102A and 102B shorted. And furthermore, this embodiment is not limited thereto, and the first switches 103 and the second switch 105 may not be linked.

In this embodiment, when the first switch 103 and the second switch 105 are electronic switches, the second switch 105 may be connected to the control signal generator 104. Hence, when the first switch 103 makes the path C turned off according to a control signal, the second switch 105 makes the data pins 102A and 102B shorted according to the control signal. Furthermore, this embodiment is not limited thereto, and the second switch 105 does not have to be connected to the control signal generator 104.

According to this embodiment, whether the electronic device exchanges data with the external device via the data pins of the port circuit is controlled by providing a switch at the port circuit. Hence, when the external device supplies power for the electronic device via the port circuit, the electronic device may be prohibited from exchanging data with the external device via the port circuit, thereby guaranteeing information security of the electronic device. Furthermore, the electronic device may be permitted to exchange data with the external device via the port circuit by switching of the switches, thereby improving flexibility of use of the port circuit.

### Embodiment 2

Embodiment 2 of this disclosure provides a method for supplying power for an electronic device via a port circuit, in which the port circuit described in Embodiment 1 is used to supply power for the electronic device.

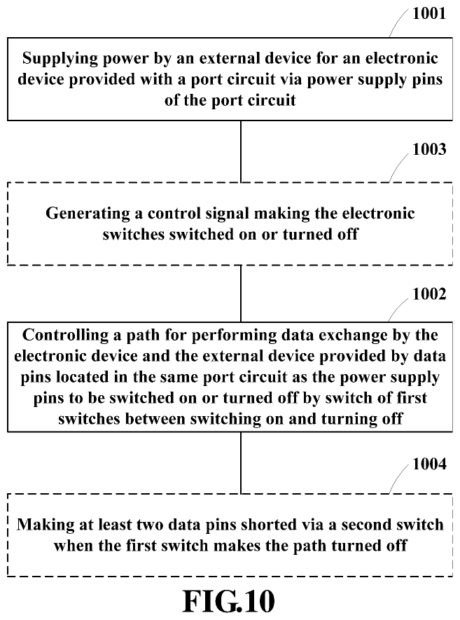

FIG. 10 is a flowchart of the method. As shown in FIG. 10, the method includes: step 1001: supplying power by an external device for an electronic device provided with a port circuit via power supply pins of the port circuit; and step 1002: controlling a path for performing data exchange by the electronic device and the external device provided by data pins located in the same port circuit as the power supply pins to be switched on or turned off by switching of the first switch between switching on and turning off.

In this embodiment, when the first switch is switched on or turned off, the data pins of the port circuit are insulated from data lines of the external device, and/or the data pins of the port circuit are interrupted.

In this embodiment, the first switch may be a mechanical switch or an electronic switch.

In this embodiment, as shown in FIG. 10, the method may further include:

step 1003: generating a control signal making the electronic switch switched on or turned off.

In this embodiment, when the first switch of the port circuit is an electronic switch, the control signal may be used to control switching on or turning off of the electronic switch.

In this embodiment, as shown in FIG. 10, the method may further include:

step 1004: making at least two data pins shorted via a second switch when the first switches make the path turned off

According to this embodiment, switching on or turning off of the path C is controlled by the switch of the port circuit. Hence, when the external device supplies power for the electronic device via the port circuit, the path C may be turned off, thereby guaranteeing information security of the electronic device. Furthermore, the path C may be switched on by switching of the switches, thereby improving flexibility of use of the port circuit.

### Embodiment 3

The embodiment of this disclosure provides an electronic device, including the port circuit as described in Embodiment 1.

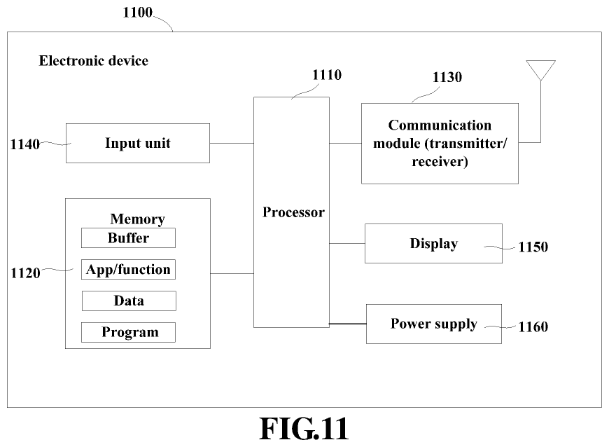

FIG. 11 is a block diagram of a systematic structure of the electronic device 1100 of the Embodiment 3 of this disclosure. As shown in FIG. 11, the electronic device 1100 may include a processor 1110 and a memory 1120, the memory 1120 being coupled to the processor 1110. It should be noted that this figure is illustrative only, and other types of structures may also be used, so as to supplement or replace this structure and achieve a telecommunications function or other functions.

In this embodiment, data lines of the electronic device 1100 are connected to the data pins of the port circuit, power supply lines of the electronic device are connected to the power supply pins of the port circuit, and FIG. 1 may be referred to for a particular manner of connection.

In this embodiment, the electronic device 1100 may include a controller (not shown). When detecting that at least two data pins of the port circuit are shorted, the controller makes the electronic device 1100 to receive power supply from the external device via the power supply pins of the port circuit. For example, the controller may be connected with two data lines of the electronic device, and when the two data pins of the port circuit are shorted, the controller may detect that the two data lines of the electronic device 1100 are at the same potential, hence, the controller may control, so as to permit power transmitted via the power supply pins of the port circuit to charge the chargeable battery of the electronic device 1100.

In one implementation, at least one of functions of the control signal generator 104 (as shown in FIG. 1) of the port circuit and functions of the controller of the electronic device may be integrated into the processor 1110. The processor 1110 may be configured to: when the switch of the port circuit is electronic switch, generate a control signal making the electronic switches switched on or turned off.

In this embodiment, the processor 1110 may further be configured to: when detecting that the at least two data pins of the port circuit are shorted, make the electronic device to receive power supply from the external device via the power supply pins of the port circuit.

In another implementation, at least one of the control signal generator of the port circuit and the controller of the electronic device and the processor 1110 may be configured separately. For example, the control signal generator of the port circuit and the controller of the electronic device may be configured as a chip connected to the processor 1110, with their functions being realized under control of the processor 1110.

As shown in FIG. 11, the electronic device 1100 may further include a communication module 1130, an input unit 1140, a display 1150 and a power supply 1160; the power supply 1160 may be, for example, a chargeable battery. It should be noted that the electronic device 1100 does not necessarily include all the parts shown in FIG. 11, and furthermore, the electronic device 1100 may include parts not shown in FIG. 11, and the prior art may be referred to.

As shown in FIG. 11, the processor 1110 is sometimes referred to as a controller or control, and may include a microprocessor or other processor devices and/or logic devices. The processor 1110 receives input and controls operations of every components of the electronic device 1100.

The memory 1120 may be, for example, one or more of a buffer memory, a flash memory, a hard drive, a mobile medium, a volatile memory, a nonvolatile memory, non-transitory memory or other suitable devices, which may store the above information related to the first information, the second information, the indication information and the identification information, and may further store a program executing related information. The processor 1110 may execute the program stored in the memory 1120, so as to realize information storage or processing, etc. Functions of other parts are similar to those of the prior art, which shall not be described herein any further. The parts of the electronic device 1100 may be realized by specific hardware, firmware, software, or any combination thereof, without departing from the scope of the present disclosure.

In this embodiment, the electronic device 1100 may include the following devices, but it is not limited thereto: a cellular phone, a personal digital assistant (PDA), a wireless modem, a wireless communication device, a handhold device, a machine-type communication device, a lap-top computer, a cordless telephone, a smart mobile phone, a smart watch, and a digital camera, etc.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

The control signal generator 104 described with reference to Embodiment 1 of this disclosure and the step 1003 of the method described with reference to Embodiment 2 of this disclosure may be directly embodied as hardware, software modules executed by a processor, or a combination thereof. For example, the control signal generator 104 shown in the functional block diagrams in FIG. 1 may either correspond to software modules of procedures of a computer program, or correspond to hardware modules. Such software modules may respectively correspond to step 1003 shown in FIG. 10. And the hardware module, for example, may be carried out by firming the soft modules by using a field programmable gate array (FPGA).

The software modules may be located in a RAM, a flash memory, a ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

1. A port circuit, comprising:
power supply pins configured to connect power lines of an external device and power lines of an electronic device provided with the port circuit;
data pins configured to connect data lines of the external device and date lines of the electronic device; and
a first switch configured to switch between switching on and turning off, so that a path for performing data exchange between the electronic device and the external device is switched on or turned off.

2. The port circuit according to claim 1, wherein,
when the first switch is switched on or turned off, the data pins are insulated from the data line of the external device, and/or the data pins are interrupted.

3. The port circuit according to claim 1, wherein,
the first switch is mechanical switch or electronic switch.

4. The port circuit according to claim 3, wherein the port circuit further comprises:
a control signal generator connected to the electronic switch and generating a control signal making the electronic switch switched on or turned off.

5. The port circuit according to claim 1, wherein the number of the data pins is at least two, and the port circuit further comprises:
a second switch connected to the at least two data pins, and making the at least two data pins electronically connect when the first switch makes the path turned off.

6. An electronic device, comprising the port circuit as claimed in claim 1.

7. The electronic device according to claim 6, wherein the electronic device further comprises:
a controller, when detecting that the at least two data pins of the port circuit electrically connect, making the electronic device to receive power supply form the external device via the power supply pins of the port circuit.

8. A method for supplying power for an electronic device via a port circuit, comprising:
supplying power by an external device for an electronic device provided with a port circuit via power supply pins of the port circuit; and
controlling a path for performing data exchange by the electronic device and the external device provided by data pins located in the same port circuit as the power suppl pins to be switched on or turned off by a switch of a first switched between switching on and turning off.

9. The method according to claim 8, wherein,
when the first switch is switched on or turned off, the data pins are insulated from a data line of the external device, and/or the data pins are interrupted.

10. The method according to claim 8, wherein,
The first switch is mechanical switch or electronic switch.

11. The method according to claim 10, wherein the method further comprises:
generating a control signal making the electronic switch switched on or turned off.

12. The method according to claim 8, wherein the number of the data pins is more than two,
and the method further comprises:
making the at least two data pins electrically connect via a second switch when the first switch makes the path turned off.
